(19) United States
(12) Patent Application Publication
(10) Pub. No.: US 2019/0329294 A1
(43) Pub. Date: Oct. 31, 2019

(54) Apparatus and Method for Processing Plant Materials

(71) Applicant: CryEx Technologies LLC., Laramie, WY (US)

(72) Inventor: Dylan Thomas Knapp, Windermere, FL (US)

(21) Appl. No.: 15/965,636

(22) Filed: Apr. 27, 2018

(51) Int. Cl. B07B 1/24; B07B 1/46; B07B 13/14; C12C 3/00

(52) U.S. Cl. CPC B07B 1/24; B07B 1/4609; B07B 2220/00; C12C 3/00; B07B 13/14

(57) ABSTRACT

The present disclosure relates to the processing of hops. More specifically, an apparatus and method for extracting lupulin from hops are disclosed. Hops are brought into contact with a cooling agent, such as dry ice, to freeze or cool the hops. This cooling is facilitated by mixing the hops and the dry ice together inside of a tumbler. The tumbler continuously rotates to mix the dry ice and hops. Further mixing is afforded by an internal agitator that sweeps the interior of the tumbler. The agitator also pulverizes the hops and separates the hops from the particulate lupulin material. The tumbler is formed from a mesh material that allows the extracted lupulin to leave the tumbler and be collected.

### TECHNICAL FIELD

This disclosure relates to the processing of plant materials. For example, the present disclosure relates to an apparatus and method for extracting lupulin from hops.

### BACKGROUND OF THE INVENTION

Beer is one of oldest and most widely consumed alcoholic beverages in the world. The science of brewing beer dates back thousands of years with some of the earliest beer recipes being developed by ancient Egyptian civilizations. Today the basic ingredients of beer are water, barley, yeast, and hops. Hops are the fragrant and cone shaped fruits produced by the Humulus Lupulus plant. Brewers harvest hops and use them as both a flavoring agent and a preservative in beer. Hops are critical in providing the bitterness to beer that is necessary to balance the sweetness of the malt. Hops also provide a variety of floral, citrus, herbal, or other flavorings.

The beneficial aspects of hops do not come from the entirety of the cone. Rather the flavoring and preservative functions are the result of lupulin glands that reside within the interior of the hops. Lupulin glands contain the soft resins and the alpha and beta acids that provide the desirable bitterness and flavoring. Lupulin is also desirable as it acts as a preservative in beer. Hops generally include a variety of less desirable components, including strigs, bracteole, and bract. These hops components serve no flavoring or preservative functions and ultimately must be filtered out during the brewing process. They also increase the cost and complexity of storage and shipping as well as subsequent brewing steps. Unfortunately, lupulin resides deep within the interior of the hops and is generally difficult to extract from the remaining hops components.

As a result of this, efforts have been made over the years to recover lupulin from other hops components. An example of this is U.S. Pat. No. 2,345,773 to Schorr. Schorr discloses a process of extracting lupulin obtained from hops. The process involves emulsifying lupulin with a hot solution in a closed container.

Another example is disclosed in U.S. Pat. No. 2,833,652 to Naatz. Naatz discloses a method of treating hops to obtain lupulin. In particular, it discloses freezing hops at a temperature of 0 degrees Fahrenheit to minus 80 degrees Fahrenheit and then shaking the hops to free the frozen lupulin particles.

Finally, U.S. Pat. No. 3,275,447 to Muller discloses a process for the preparation of dry hops concentrate that contains substantially all the lupulin components of the hops. It involves freezing the hops to a temperature of less than minus 10 degrees Celsius. It further involves a process in which the lupulin particles are sintered together into clumps.

Thus, although various efforts have been made to extract lupulin, they all suffer from common draw backs. In particular, none of the background art discloses a mechanical apparatus for both agitating and cooling hops. Nor does the background art disclose an apparatus for agitating and then screening the hop components from the lupulin particles. Finally, the background art does contemplate an apparatus for thereafter collecting the particulate lupulin material. The apparatus and method of the present disclosure are designed to overcome these and other drawbacks present in the background art.

### SUMMARY OF THE INVENTION

It is therefore an object of the present disclosure to provide a mechanical apparatus for efficiently extracting lupulin from hops.

It is a further object of this disclosure to provide a method for processing hops that involves cooling the hops.

It is still yet a further object of the present disclosure to provide an apparatus for extracting lupulin from hops that is portable and that can be easily stored and cleaned.

Another object of the present disclosure is to provide an apparatus for extracting lupulin that utilizes an agitator for both mixing the hops and pulverizing the hops components.

Still yet a further object of the present disclosure is to provide a lupulin extraction apparatus that utilizes a mesh screen that is dimensioned to permit lupulin particles to be filtered and collected.

And yet a further object of the present disclosure is to provide a device for collecting all of the extracted lupulin particles.

In other embodiments the apparatus of the present disclosure is used in extracting cannabidiol (“CBD”) and/or Tetrahydrocannabinol (“THC”) from cannabis.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a partially exploded view of the apparatus of the present disclosure.

FIG. 2 is a front elevational view of the apparatus of the present disclosure.

FIG. 3 is a side elevational view of the apparatus of the present disclosure.

FIG. 4 is a side elevational view of the apparatus of the present disclosure.

FIG. 5 is a detailed view of the tumbler and screen employed in the apparatus of the present disclosure.

FIG. 6 is a partial sectional view of the apparatus of the present disclosure.

FIG. 7 is a detailed view of the agitator of the present disclosure.

FIG. 8 is a view of an alternative embodiment of the present disclosure.

### DETAILED DESCRIPTION OF THE DRAWINGS

The present disclosure relates to the processing of hops. More specifically, an apparatus and method for extracting lupulin from hops are disclosed. Hops are brought into contact with a cooling agent, such as dry ice, to freeze or cool the hops. This cooling is facilitated by mixing the hops and the dry ice together inside of a tumbler. The tumbler continuously rotates to mix the dry ice and hops. Further mixing is afforded by an internal agitator that sweeps the interior of the tumbler. The agitator also pulverizes the hops and separates the hops from the particulate lupulin material. The tumbler is formed from a mesh material that allows the extracted lupulin to leave the tumbler and be collected.

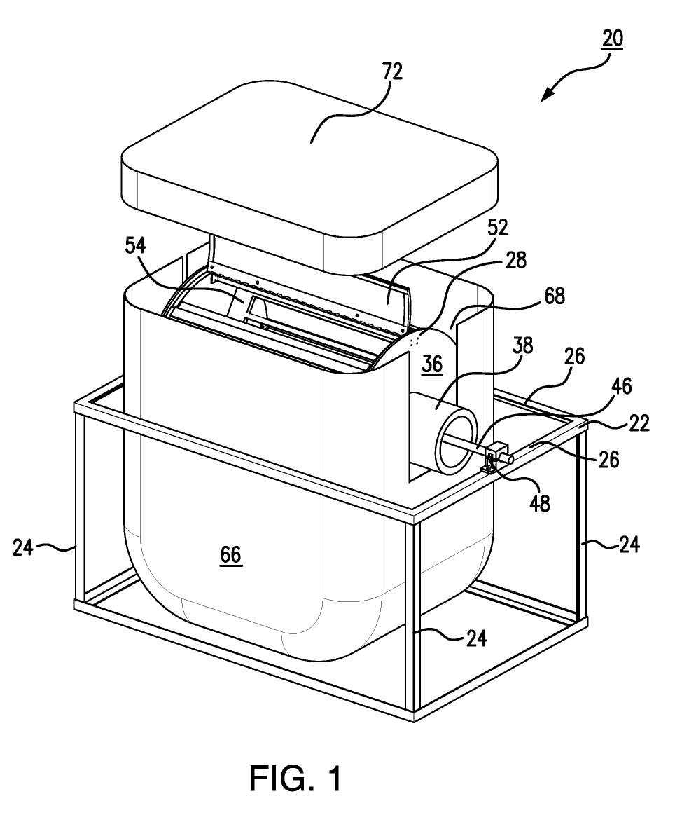

With reference now to FIG. 1, the apparatus 20 of the present invention is depicted. The apparatus 20 is designed to extract lupulin particles from hops. As noted, apparatus 20 is supported either on the ground or other surface by way of a frame 22. In the depicted embodiment, frame 22 is rectangular in shape with four upstanding members 24 and an upper peripheral extent 26. As more clearly illustrated in FIG. 5, frame 22 supports a cylindrical tumbler 28 that is adapted to rotate with respect to frame 22. Tumbler 28 includes an interior area 32, opposing ends, and an intermediate extent 34. Mounting plates 36 are secured to either end of tumbler 28.

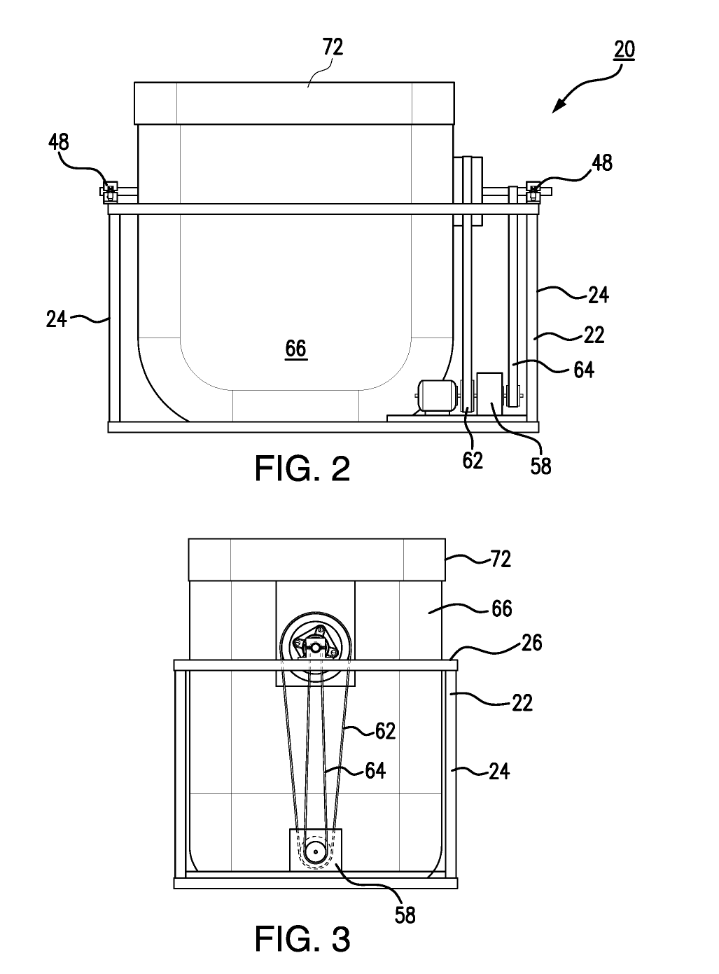

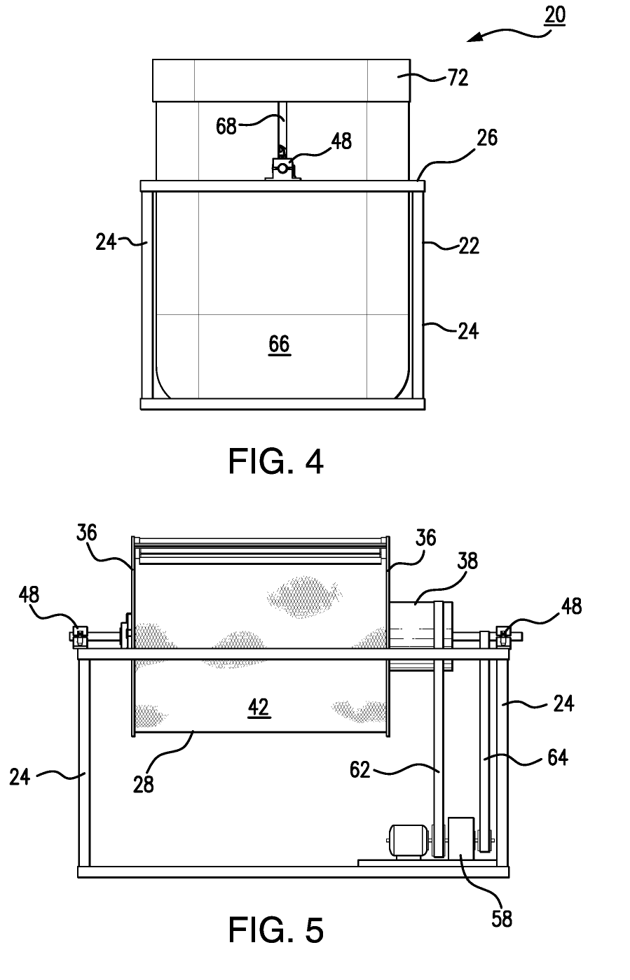

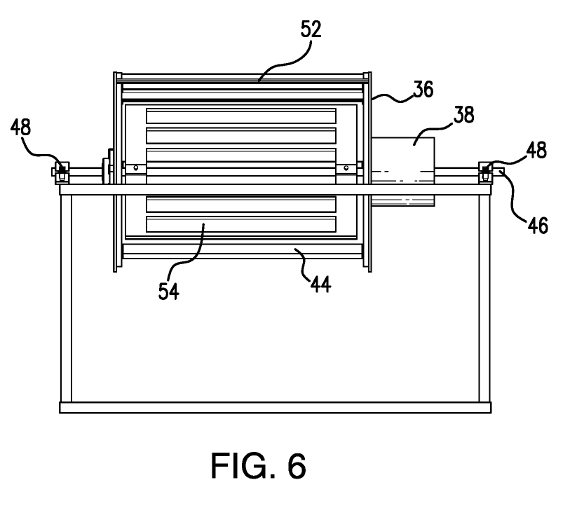

In the depicted embodiment, one of these mounting plates 28 includes a cylindrical drive member 38 that allows an associated motor 58 and belt 62 to rotate tumbler 28 (FIGS. 2 and 3). The cylindrical side wall of tumbler 28 is formed entirely from a thin mesh screen 42 that has a mesh size of approximately 200-1000 microns. Mesh screen 42 extends fully between opposing mounting plates 36. If necessary, internal bracing bars 44 can be formed on the interior of the mesh 42 to prevent it from collapsing and otherwise maintaining the rigidity of tumbler 28. Tumbler 28 rotates about a central axle 46 that mounts tumbler 28 to the peripheral extent 26 of frame 22. In this regard, axle 46 may be mounted to frame 22 at either end by bearing elements 48. A portion of the exterior surface of tumbler 28 includes a door 52. Door 52 may be formed of the same mesh material as the majority of tumbler 28. Door 52 allows the user gain access to the interior area 32 and place the hops and dry ice as described hereinafter.

The operator opens door 52 to place a volume of hops to be processed. The user also places the cooling agent, which in the preferred embodiment is dry ice. Ideally, the dry ice is broken down into smaller chunks or particles ranging anywhere between approximately 0.5 to 3 inches in length. The dry ice functions in both cooling and abrasively contacting the hops. It has been found that cooling the hops allows the lupulin material therein to be more easily extracted.

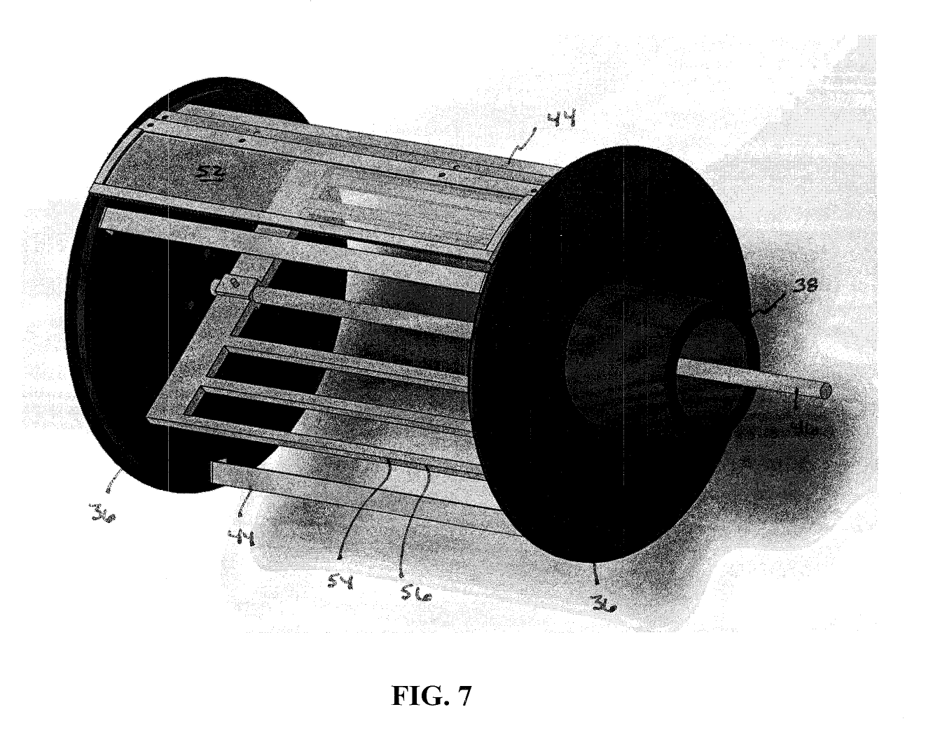

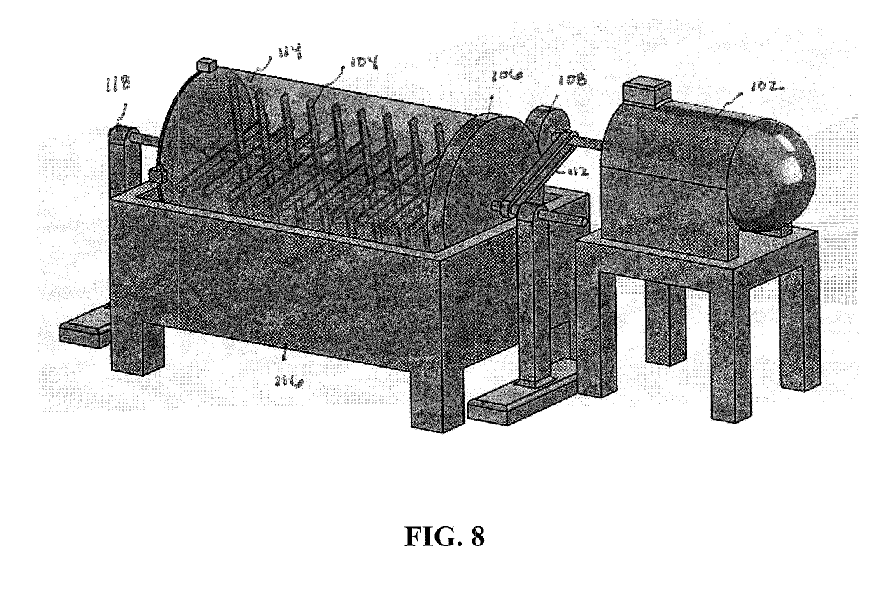

The extraction and cooling are further facilitated by an agitator 54 that is positioned along the central axle 46 of tumbler 28 and is positioned within the interior area 32. Agitator 54 preferably includes a series of arms 56 (FIG. 7) that rotate about central axle 46. Arms 56 function in sweeping the interior of tumbler 28 and in pulverizing the hops to extract the lupulin. Both the cylindrical tumbler and the agitator are powered by an associated motor 58. Motor is illustrated in FIGS. 2 and 3. Motor 58 powers both a first tumbler drivetrain (or belt 62) and a second agitator drivetrain (or belt 64). These drivetrains may take other forms that extend from a power takeoff on the motor to an associated axle. The size of the axles are chosen to provide the desired rates of the rotation. In particular, tumbler drivetrain 62 drives at a first rate of rotation and the agitator drivetrain 64 drives at a second rate of rotation. The second rate of rotation is substantially greater than the first right of rate of rotation. In one embodiment, the agitator rotates at 500-2000 RPM and tumbler rotates at 1-60 RMP.

Next, a collector 66 is designed to fit about the entirety of tumbler 28. In this regard, collector 66 includes elongated slots 68 at either end to accommodate the central axle 46. Collector 66 includes an upper lid 72 to provide a complete contained enclosure. Collector 66 is designed to accumulate any lupulin particles that are separated from the hops and are filtered by screen 42. The hops, whether emanating from the top or sides of the tumbler, will eventually accumulate at the bottom of collector 66. Once the processing is complete, the operator can access the harvested lupulin from the bottom of collector 66.

FIG. 7 illustrates another embodiment of the present invention. It utilizes a motor 102 to drive both the agitator 104 and the tumbler 106. The drive system includes a drive wheel 108 to rotate the tumbler 106 and a belt 112 to rotate the agitator. The tumbler 106 is surrounded by a mesh material 114. A tub 116 is positioned underneath and around the bottom of the tumbler 106. Bearing 118 supports are provided at either end of the axle to allow for the rotation of both the agitator 104 and tumbler 106.

The invention is a method and apparatus to separate lupulin from hops using a cryo-pulverizing technique. Lupulin is a yellow, waxy substance contained within the bract of the hop cone. The present apparatus detaches this useful beer making material from the less valuable plant matter (i.e. the bract) via a mechanical system and dry ice (solid carbon dioxide).

The objective of the present invention is to separate lupulin from the hop. To accomplish this task, a combination of stirring/mixing and pulverizing is used in conjunction with dry ice to remove the lupulin glands from the hop. The invention can be broken into separate components: drivetrain, agitator, tumbler, capture system, and miscellaneous.

### Drivetrain

For this invention to function properly, it must be driven by one or more motors. The motor(s) may be either electric or gas powered devices. The function of the motor is to spin the tumbler and agitator. Because the tumbler will rotate at a much lower speed than the agitator, multiple motors may be used to vary either speed as needed. If one central motor is used, gear ratios may be implemented to vary the rotational velocity between the tumbler and agitator (FIG. 7). Power may be transmitted from motor to tumbler or agitator via gears, belts and sheaves, or sprockets and chains. The agitator may be driven in a direction opposite of the tumbler via a gear box.

### Agitator

The purpose of the agitator is to break apart the hops and promote mixing between dry ice and hops. In the embodiment of FIG. 7, an agitator has a shaft with fixed blade-like fins to break apart hops. Any possible arrangements and/or dimensions of fins may be used to successfully promote separation of hops and lupulin. Preliminary tests have shown that vigorous mixing significantly increases the yield of lupulin powder when paired with dry ice. Therefore, the agitator will rotate at a significant rate (for example, in one embodiment at approximately 500-2000 RPM). Agitator speed is controlled by the motor to vary the rate of mixing. If mixing is too aggressive hops will be completely destroyed and plant matter will pass through the filtration system, but if mixing is too moderate hops will not be broken apart to allow lupulin to fall out.

### Tumbler

The tumbler is a cylindrical basket or other container that will allow lupulin to pass through but contain plant matter inside; in one embodiment a mesh screen is used. Mesh screen sizes may be varied, for example between 200 and 1000 microns. In one embodiment, the mesh is removable/interchangeable for ease of cleaning and control of size. In one embodiment, the mesh is mounted on the exterior of a birdcage-like frame with ends that are supported on the agitator's shaft via bearings. The basket/container (frame and mesh) rotates, as aforementioned, at a speed much less than the agitator (likely 1-60 RPM, in one embodiment) with the intent that it will help negate stagnation of the hops on the bottom and allow more lupulin to pass through.

### Capture System

The capture system used in the present invention collects the lupulin powder that passes through the mesh. It is important that this system works effectively to minimize waste/losses. There are several general arrangements to achieve this objective. In one embodiment, there is a simple tub/tray sitting underneath the tumbler and agitator that utilizes gravity to capture lupulin. However, a major limitation may be any airflow (both external and that created from motion of the agitator) blowing lupulin into the ambient environment. To remedy this, in another embodiment of the present invention, there is a full enclosure around the entire device to limit these losses from external airflow. An alternative embodiment is a vacuum system that creates negative pressure immediately around the tumbler. The lupulin is captured, for example on a screen.

### Miscellaneous

All materials used by this invention, specifically those that encounter hops/lupulin powder, are of food grade quality as outlined by the NSF—Public Health and Safety Organization. In other words, the agitator, tumbler, capture system and other relevant components of any embodiments of the invention are built with food grade quality materials, for example stainless steel (e.g. AISI 316 SS). This facilitates sanitary practices when using this invention. Likewise, the mesh used to separate lupulin (could also be stainless steel) is removable to allow cleaning and access to the agitator. Moreover, all components are replaceable/interchangeable for ease of maintenance and repair. Finally, dry ice is a critical component to this invention, which is very effective in separating lupulin from the hop. The extreme cold temperature paired with the abrasive nature of dry ice is an inexpensive, but effective, method of creating lupulin powder.

Apparatus 20 has been disclosed for use in extracting lupulin from hops. However, apparatus 20 can similarly be used to extract other beneficial ingredients from a variety of plant materials. The steps and structures detailed above would be unchanged; however, plant material other than hops would be added to agitator 54 in addition to the dry ice. For example cannabis can be added to agitator 54 along with dry ice and thereafter agitated and filtered to extract cannabidiol (“CBD”) and/or Tetrahydrocannabinol (“THC”).

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. An apparatus for extracting lupulin from hops, the apparatus comprising:
a rectangular frame for supporting the apparatus upon a surface, the frame including an upper peripheral extent;
a cylindrical tumbler adapted for rotation with respect to the frame, the tumbler including an interior area, opposing ends, and an intermediate extent, mounting plates secured at the opposing ends, a mesh screen extending between the mounting plates, the mesh screen allowing particles of between approximately 200 to 1000 microns to pass therethrough, a central axle rotatably mounting the tumbler to the peripheral extent of the frame, a door formed within the mesh screen to provide access to the interior of the tumbler;
a volume of hops and particulate dry ice positioned within the interior area of the tumbler, the dry ice functioning to cool and abrasively contact the hops and thereby facilitate the separation of the lupulin from the hops;
an agitator positioned along the central axle of the tumbler and positioned within the interior area, the agitator including a series of arms that functioning in sweeping the interior of the tumbler and further separating the lupulin from the hops;
a motor powering both a tumbler drive train and an agitator drive train, the tumbler drive train rotating the tumbler at a first rate of rotation, the agitator drive train rotating the agitator at a second rate of rotation, with the second rate of rotation is substantially greater than the first rate of rotation;
a collector positioned about the tumbler and functioning to collect the lupulin passing through the mesh screen.

2. An apparatus for extracting lupulin from hops comprising:
a tumbler including an interior, a screen, and an axle for rotatably mounting the tumbler;
a volume of hops and particulate frozen matter positioned within the interior of the tumbler, the frozen matter functioning to cool and abrasively contact the hops and thereby facilitate the extraction of the lupulin;
an agitator positioned within the interior of the tumbler, the agitator mixing the hops and frozen matter and separating the lupulin from the hops;
a motor powering both the tumbler and the agitator;
a collector positioned adjacent tumbler and functioning to collect the lupulin passing through the screen.

3. The apparatus as described in claim 2 wherein the tumbler is cylindrical and the axle is centrally mounted.

4. The apparatus as described in claim 2 wherein the frozen matter is dry ice that is broken down into pieces of between ½ inch and 3 inches.

5. The apparatus as described in claim 2 wherein the screen allows for the passage of particles having a diameter of approximately 200 to 1000 microns.

6. The apparatus as described in claim 2 wherein the tumbler and agitator rotate in opposite directions.

7. The apparatus as described in claim 2 wherein the agitator rotates at a rate of between approximately 500 and 2000 RPMs.

8. The apparatus as described in claim 2 wherein the tumbler rotates at a rate of between approximately 1 and 60 RPMs.

9. The apparatus as described in claim 2 further comprising a door positioned within the tumbler to gain access to its interior.

10. A method of using dry ice to extract lupulin from hops, the method comprising the following steps:
breaking the dry ice into smaller particles;
combining the dry ice particles and the hops, the contact between the dry ice particles and hops decreasing the temperature of the hops;
agitating the dry ice particles and hops, whereby the dry ice particles abrasively contact the hops and the lupulin is extracted from the hops;
passing the extracted lupulin through a mesh screen whereby the lupulin is separated from the remaining hops materials;
collecting the screened and extracted lupulin.
